(19) United States
(12) Patent Application Publication
(10) Pub. No.: US 2009/0068441 A1
(43) Pub. Date: Mar. 12, 2009

(54) Thermal interface materials

(76) Inventors: Srinivas H. Swaroop, Acton, MA (US); Timothy D. Davis, Tewksbury, MA (US); Andrea O. Barney, Bedford, MA (US)

Correspondence Address: LAW DEPARTMENT;CABOT CORPORATION, 157 CONCORD ROAD, BILLERICA, MA, 01821, US

(21) Appl. No.: 12/231,177

(22) Filed: Aug. 29, 2008

Related U.S. Application Data
(60) Provisional application No. 60/967,284, filed on Aug. 31, 2007.

(51) Int. Cl. B32B 5/16; C09K 5/14

(52) U.S. Cl. 428/329; 252/75; 252/74

(57) ABSTRACT

The present invention relates to thermal interface materials comprising a filler dispersed in a polymer, wherein the filler has an average aggregate particle size of less than or equal to 1 micron. Preferably the filler is a synthetic alumina, such as fumed alumina.

### CROSS-REFERENCE TO RELATED APPLICATIONS

This patent application claims the benefit of U.S. Provisional Patent Application No. 60/967,284, filed Aug. 31, 2007.

### BACKGROUND OF THE INVENTION

1. Field of the Invention

The present invention relates to thermal interface materials comprising at least one thermally conductive filler dispersed in a polymer and having an average aggregate particle size of less than or equal to 1 micron.

2. Description of the Related Art

As semiconductor chips and components become increasingly powerful and more densely packaged into devices, the need to dissipate heat generated by these components has become ever more important. In fact, in many instances, thermal management issues are the limiting factors in performance of electronic devices.

From a thermal management standpoint, most of these systems can be considered to consist of three components: 1) a heat generating component or heat source (e.g., a chip or a circuit board), 2) a heat dissipating device or heat sink, and 3) a thermal interface material (TIM), which serves primarily to provide a compliant interface that ensures effective contact for heat transfer between the heat source and the heat sink. As such, thermal interface materials are often silicone elastomers or silicone greases filled with thermal conductivity enhancing fillers. In most cases, although not all, thermal interface materials are also required to be electrically insulating.

As a result, thermally conducting dielectric fillers such as alumina, boron nitride or aluminum nitride are often used in thermal interface materials. Alumina has a relatively high thermal conductivity (generally about 18 W/mK) and represents a good cost/performance tradeoff. Boron nitride, with a 50% higher intrinsic thermal conductivity than alumina, is used in high performance applications that can justify the higher cost. Aluminum nitride has excellent thermal conductivity (8-10 times that of alumina) but has stability issues in addition to its very high cost. For example, U.S. Pat. No. 6,160,042 describes a method for forming low viscosity thermally conductive polymer composites by using treated boron nitride particles. Also, U.S. Patent Publication No. 2005/0049350 describes compositions that contain alumina fillers, including blends of different particle sizes, and which may be treated with organic reagents to promote adhesion of the alumina to the polymer matrix (such as alkoxysilanes, aryloxysilanes, oligosiloxanes, etc.). U.S. Pat. No. 6,096,414 also describes the use of blends of fillers with coarse and fine particles (including alumina).

A typical elastomeric thermal interface material comprises a silicone matrix heavily filled with greater than 40-50% by weight of fillers such as alumina in an attempt to obtain a conductive pathway through the composition. To be able to accommodate such high filler loadings, the alumina is generally a non-synthetic or “coarse” alumina, having an average aggregate particle size of several microns and a very low surface area (generally less than 5 m²/g). This keeps the viscosity of the filled silicone acceptable at high filler loadings permitting their fabrication into pads such as by injection molding. However, despite the high loadings of alumina, the thermal conductivity of the composite elastomer is substantially less than that of alumina, seriously limiting the heat dissipation characteristics of the system.

Therefore, there is a need for more effective fillers that provide thermal interface materials having significantly improved thermal conductivity over current materials. As semiconductor devices become more powerful, the attendant heat dissipation presents a more significant problem seeking a technical solution.

### SUMMARY OF THE INVENTION

The present invention relates a thermal interface material comprising a filler dispersed in a polymer. The filler has an average aggregate particle size of less than or equal to 1 micron. Preferably the filler is a fumed, precipitated, or colloidal alumina, which may further be treated to form a modified alumina comprising an alumina having attached at least one organic group. The thermal interface material may further comprise at least one second thermally conductive filler having an average aggregate particle size of greater than or equal to 1 micron and/or may further comprise at least one reinforcing filler. The present invention further relates to an electronic device comprising the thermal interface material.

It is to be understood that both the foregoing general description and the following detailed description are exemplary and explanatory only and are intended to provide further explanation of the present invention, as claimed.

### BRIEF DESCRIPTION OF THE DRAWINGS

FIG. 1 and FIG. 2 show viscosity vs. shear rate profiles for thermal interface materials comprising various fumed alumina fillers.

### DETAILED DESCRIPTION OF THE INVENTION

The present invention relates to thermal interface materials comprising at least one filler dispersed in a polymer and having an average aggregate particle size of less than or equal to 1 micron. As used herein, the term “thermal interface material” is defined as a thermally conductive composition that provides contact between a heat generating component (the heat source) and a heat dissipating component (the heat sink) in order to permit effective heat transfer. The thermal interface material may be in the form of a solid or in the form of a highly viscous liquid, such as an adhesive, grease, or paste.

The filler of the thermal interface material of the present invention has an average aggregate particle size of less than or equal to 1 micron, including less than or equal to 750 nm and less than or equal to 500 nm. The filler can be any thermally conductive material, including, for example, silica (fumed, precipitated, colloidal, or amorphous), finely divided quartz powder, carbon black, graphite, diamond, a metal (such as silver, gold, aluminum, and copper), silicon carbide, an aluminum hydrate, a metal nitride (such as boron nitride, and aluminum nitrides), a metal oxide (such as alumina, titania, zinc oxide, or iron oxide), or combinations thereof. Preferably the filler has a high conductivity, such as a conductivity of greater than or equal to about 10 W/mK, including greater than or equal to about 15 W/mK. Thermally conductive fillers that are also minimally electrically conductive are most preferred, and include dielectric materials such as alumina, boron nitride, and aluminum nitride. The filler may further have morphological characteristics that provide additional reinforcement properties to the polymer, and as such would therefore also be considered to be a reinforcing filler in addition to being a thermally conductive filler.

The filler has an average aggregate particle size of less than or equal to 1 micron, but may further comprise larger particles, such as agglomerates. For example, it is known that pyrogenic metal oxides, such as fumed alumina, are formed by the aggregation of primary particles which, in turn, form agglomerates. Primary particle size, aggregate size, and agglomerate size are independent properties. The average size of the primary particles are typically in the 10 nm range while the average aggregate particle size is generally less than or equal to 1 micron, and often less than or equal 500 nm, such as between about 100 and 250 nm. These aggregates may then agglomerate, forming particles having an average particle size that is several orders of magnitude larger—generally in the 50-100 micron range or larger. Thus, the filler used in the thermal interface material of the present invention may have an average agglomerate size of greater than 1 micron but has an average aggregate particle size of less than or equal to 1 micron, which may be typically observed when dispersed in a matrix, such as the polymer, thereby breaking up the agglomerates to the aggregate level. Average particle size, as used herein, refers to the average by volume.

Preferably, the filler is a synthetic material, which is a filler prepared by a chemical process from a precursor material, rather than being a filler that is isolated and purified from a naturally occurring ore and accordingly size reduced. Synthetic materials can be prepared with greater control over their particle size and morphology and, as such, provide advantages over naturally occurring fillers. For example, the filler can be a synthetic alumina, which includes precipitated and colloidal alumina (prepared, for example, from the hydrolysis of aluminum alkoxides) or fumed alumina (prepared by a pyrogenic process from, for example, an aluminum halide). Synthetic alumina differs from so-called “Bayer process” alumina (sometimes also referred to herein as “coarse” alumina), which is a non-synthetic alumina isolated from naturally occurring ores, in both morphology (also referred to as structure) and surface area. For example, non-synthetic aluminas generally have an average aggregate particle size substantially greater than 1 micron, often in the tens of microns, while synthetic aluminas have smaller average aggregate particle sizes. Thus, the fillers used in the thermal interface materials of the present invention preferably have a surface area greater than or equal to 30 m²/g, including greater than or equal to 40 m²/g and greater than or equal to 50 m²/g. In addition, the filler may also have a surface area less than or equal to 250 m²/g, such as less than or equal to 200 m²/g and less than or equal to 100 m²/g. Therefore, for example, the filler may have a surface area of between 30 m²/g and 250 m²/g or ranges therein, such as between 50 m²/g and 200 m²/g or between 100 m²/g and 250 m²/g.

In general, fillers having an average aggregate particle size of less than 1 micron were avoided in thermal interface materials primarily due to an expectation of creating viscosity build issues. This was particularly expected for synthetic fillers, such as fumed alumina, based on the morphological properties of fumed alumina. Furthermore, the higher surface area associated with average aggregate particle sizes below 1 micron were expected to lead to higher scattering losses at the filler-polymer interfaces, simply because there would be a larger interfacial area with such fillers. However, contrary to what was previously believed, it is expected that fillers having this low average aggregate particle size, particularly fumed alumina, can be effectively used to produce a thermal interface material, without any of the above identified issues. In addition, the thermal conductivity of these materials is expected to be improved. For example, the thermal impedance presented by the mating of the thermal interface material to the heat generating component and heat sink surfaces drives the heat transfer rate. In addition to the intrinsic thermal conductivity of the TIM, the thermal impedance is also driven by its thickness, as well as by the contact resistance of the two mating surfaces. The use of fillers, such as fumed alumina fillers, having an average aggregate particle size of less than 1 micron, should enable fabrication of thinner thermal interface materials having, for example, a thickness of less than or equal to 50 μm or even less than or equal to 25 μm), which should significantly enhance their performance. Furthermore, the use of such fillers should enable fabrication of materials having a smoother surface, which will improve the contact with the mating surfaces. In addition, the use of fumed alumina fillers could enable the formulation of a TIM with better conformability (lower bulk modulus). These will reduce the contact resistance and the overall thermal impedance of the system, resulting in improved heat dissipation performance.

The filler of the thermal interface material of the present invention may also be a treated thermally conductive filler. For example, the filler may be a modified alumina, such as a modified fumed alumina, comprising an alumina, such as a fumed alumina, having attached at least one organic group. Any method known in the art for attaching organic groups to the filler may be used including, for example, chemical reaction of the filler with a surface modification reagent. The choice of organic group will depend on a variety of factors, including, for example, the type of polymer and the reactivity of the filler. It would be expected that, for example, surface treatment of a fumed alumina filler would result in a reduction in viscosity build due to the greater dispersibility of the modified filler in the polymer. This should enable higher loadings of the alumina filler and in turn, lead to higher thermal conductivity of the composite material (without viscosity limitations that would preclude formation of the thermal interface material). This may also be critical to permit the use of fumed alumina in some silicone formulations, described below. Furthermore, a treated thermally conductive filler, such as a modified fumed alumina, would also be expected to have greater compatibility with the polymer, which would be expected to reduce phonon scattering losses as heat is conducted through the filler network and is transferred across the filler/polymer boundaries or interfaces. In addition, improved dispersion of high surface area modified fillers in the polymer would lead to a more effective filler use. For example, a better dispersion increases the probability of particle-to-particle contact and in turn to more efficient and effective thermal percolation networks.

The polymer of the thermal interface material of the present invention may be any polymer known in the art for such an application. For example, the polymer may be a polydimethylsiloxane resin, an epoxy resin, an acrylate resin, a organopolysiloxane resin, a polyimide resin, a fluorocarbon resin, a benzocyclobutene resin, a fluorinated polyallyl ether resin, a polyamide resin, a polyimidoamide resin, a cyanate ester resin, a phenol resol resin, an aromatic polyester resin, a polyphenylene ether resin, a bismaleimide triazine resin, a fluororesin, or combinations thereof. Blends of polymers may also be used. The polymer may be a thermoplastic or a thermoset, and may have a low or high molecular weight and T_{g} depending on the desired final properties (such a viscosity, modulus, elasticity, etc.). Suitable examples of curable thermoset matrices include acrylate resins, epoxy resins, and polydimethylsiloxane resins, as well as other organo-functionalized polysiloxane resins that can form cross-linking networks via free radical polymerization, atom transfer, radical polymerization ring-opening polymerization, ring-opening metathesis polymerization, anionic polymerization, cationic polymerization or any other method known to those skilled in the art. For non-curable polymers, the resulting thermal interface material can be formulated as a gel, grease or phase change materials that can hold components together during fabrication and provide heat transfer during operation.

As a specific example, the polymer may be a polysiloxane resin, such as an addition curable silicone rubber composition. Such compositions include at least one organopolysiloxane component (such as an organopolysiloxane containing an average of at least two silicon-bonded alkenyl groups per molecule), at least one organohydrogenpolysiloxane, which acts as a crosslinking agent (such as an organohydrogenpolysiloxane containing an average of at least two silicon-bonded hydrogen atoms per molecule), and a hydrosilylation catalyst (such as a ruthenium, rhodium, platinum, or palladium complex), and optionally at least one catalyst inhibitor (used to modify the curing profile and to achieve improved shelf life) and at least one adhesion promoter. Specific types and amounts of each component will be known to one skilled in the art.

The polymer may further comprise various known additives to achieve the desired overall properties of the thermal interface material. For example, reactive organic diluents may be added in order to decrease the viscosity of the polymer when combining with the filler. Also, an unreactive diluent may be added to decrease the viscosity of the formulation. Furthermore, the polymer may also comprise at least one pigment or pigment mixed with a carrier fluid (such as in a pigment masterbatch). Flame retardants can also optionally be used. When the polymer is an epoxy resin, various known hardeners, curing agents, and/or other optional reagents may be used in combination with the curing catalyst.

The relative amounts of the filler and the polymer can be varied depending on the desired overall properties of the thermal interface material. For example, the filler may be dispersed in the polymer in an amount of between about 5% and about 80% by weight based on the total weight of the material, including, for example, between about 10% and about 70% or about 30% and about 60% by weight based on the total weight of the material. The amount of filler will depend, for example, on the type of polymer and the size, morphology, and chemical properties of the filler. Higher levels would be desirable to provide increased thermal transfer between the heat source and the heat sink. However, higher levels may also produce an undesirable increase in viscosity.

The thermal interface material of the present invention may further comprises at least one second filler having an average aggregate particle size of greater than 1 micron. For this embodiment, the thermal interface material therefore comprises a blend of two different fillers, one having an average aggregate particle size of less than 1 micron and one having an average aggregate particle size of greater than 1 micron. For example, the filler having an average aggregate particle size of less than 1 micron may be fumed alumina, such as a treated fumed alumina, and the second filler, having an average aggregate particle size greater than 1 micron, may be a silica (such as a fused or amorphous silica), finely divided quartz powder, graphite, diamond, a metal (such as silver, gold, aluminum, and copper), silicon carbide, an aluminum hydrate, a metal nitride (such as boron nitride and aluminum nitride), a metal oxide (such as a non-synthetic alumina, titania, zinc oxide, or iron oxide), or combinations thereof. The second filler may also be a treated filler, such as a modified filler comprising a filler having attached at least one organic group, including, for example, a modified non-synthetic alumina. The second filler and the fumed alumina can be present in a ratio of from about 2/1 to about 5/1, including from about 3/1 to about 4/1. Also, the second filler and the fumed alumina can be dispersed in the polymer in a total amount of between about 25% and about 90% by weight based on the total weight of the material, including between about 35% and about 85% or about 40% and about 80% by weight based on the total weight of the material. By combining two different particle size ranges, enhancement of thermal percolation network formation would be expected, with the small particles filling the gaps between the larger particles. Blends of coarse and fine treated alumina fillers would also be expected to optimize viscosity, filler loading and thermal conductivity properties as well as to enable a more attractive thermal dissipation performance per unit cost of fillers used.

In addition, or in the alternative, the thermal interface material of the present invention may further comprise a reinforcing filler. For this embodiment, the thermal interface material therefore comprises a blend of two different fillers, one having an average aggregate particle size of less than 1 micron and one that provides additional reinforcement to the polymer. Blends of these types of fillers would be particularly useful for preparing thermal interface materials from polymers having relatively poor physical properties. For example, a polysiloxane polymer, such as a silicone elastomer, does not have sufficient mechanical strength alone to be useful in most applications and, as a result, are typically filled with reinforcing fillers such as fumed silica or precipitated silica. The levels of reinforcing fillers required for sufficient mechanical robustness is generally about 20-40% by weight. For use as an elastomeric thermal interface material, a thermally conductive filler would then also need to be added above and beyond this loading of silica fillers required for mechanical strength. Stated differently, a silica filler would be needed to provide the requisite mechanical properties and a thermally conductive filler would be added to enhance the thermal conductivity. Thus, the enhancement of the thermal conductivity of elastomeric thermal interface materials is limited in part due to this use of multiple fillers because the reinforcing filler (such as silica) provides little enhancement in thermal conductivity.

It would be expected that a substantial reduction or, preferably, a complete elimination of the reinforcing filler can be achieved for elastomeric thermal interface materials through the use of thermal conductivity fillers having an average aggregate particle size of less than 1 micron. For example, an alumina filler has an intrinsic thermal conductivity that is about 8-10 times greater than that of silica. However, it has not been possible to reduce or eliminate the silica filler in elastomeric thermal interface materials by substituting it with the conventional non-synthetic alumina fillers because these fillers have a low surface area and low structure (non-reinforcing morphology). As such, they cannot provide the requisite mechanical reinforcement. By comparison, fumed alumina, for example, can serve as a dual function filler, providing both mechanical reinforcement (by virtue of its relatively higher surface area and morphology or structure) and thermal conductivity (inherent to alumina). By using a fumed alumina in place of some or all of the fumed silica, or other reinforcing filler, a thermal interface material having both a good balance of properties can be obtained. Thus, the thermal interface material of the present invention may further comprise between about 0% to about 30% by weight, including between about 0% and about 10% by weight, of a reinforcing filler, based on the total weight of the material.

As described above, the thermal interface material of the present invention is a thermally conductive composition that provides improved contact and increased heat transfer between a heat generating component (the heat source) and a heat dissipating component (the heat sink). As such, the thermal interface materials of the present invention can therefore be used in a variety of application in which heat is generated and needs to be removed, including, for example, for removing heat from a motor or engine, to act as underfill material in a flip-chip design, as die attach in an electronic device, or in any other applications where efficient heat-removal is desired. In particular, the thermal interface materials of the present invention may be used in electronic devices such as computers, semiconductors, or any device where heat transfer between components is needed.

Thus, the present invention further relates to an electronic component comprising: a) a heat generating component, b) a heat dissipating component, and c) a thermal interface material interposed between the heat generating component and the heat dissipating component. The thermal interface material comprises a filler dispersed in a polymer, and wherein the filler has an average aggregate particle size of less than or equal to 1 micron. The thermal interface material, polymer, and filler can be any of those described in more detail above. The materials may be pre-formed into sheets or films and cut into any desired shape and therefore can be can advantageously be used to form thermal interface pads or films that are positioned between electronic components. Alternatively, the composition can be pre-applied to either the heat generating or heat dissipating unit of a device. The present compositions may also be applied as grease, gel and phase change material formulations.

The present invention will be further clarified by the following examples which are intended to be only exemplary in nature.

### EXAMPLES

### Examples 1-2 and Comparative Example 1

The following examples demonstrate an embodiment of the thermal interface materials of the present invention, comprising a filler having an average aggregate particle size of less than or equal to 1 micron dispersed in a polymer and further comprising a filler having an average aggregate particle size of greater than 1 micron.

The following general procedure was used to prepare thermal interface materials of the present invention (Examples 1-2) as well as a comparative thermal interface material (Comparative Example 1). 25.68 g of a vinyl terminated polydimethylsiloxane fluid (DMS-V33 available from Gelest Inc., Morrisville, Pa., 3500 cSt) and 65.0 g of an alumina filler were weighed into a mixing cup. The mixture was mixed for 10 minutes on a Hauschild SpeedMixer™ DAC 150 at 3500 rpm. To this was added 2.1 g of a methylhydrosiloxane containing dimethylsiloxane copolymer crosslinker (HMS-151 available from Gelest) and mixed at 2000 rpm for 2 minutes. To this was then added 0.06 g of a tetravinyltetramethylcyclotetrasiloxane inhibitor (SIT 7900 available from Gelest) and further mixed at 2000 rpm for 1 minute and then at 3500 rpm for several iterations at 20 seconds on the SpeedMixer™ DAC 150. Finally, a platinum carbonyl complex catalyst (SIP 6829 available from Gelest) was added to the mixture and mixed at 2000 rpm for 1 minute and then at 3500 rpm for 20 sec, repeating the higher speed mixing cycle several times as necessary to get a good mixture. The entire mixture was transferred to a sealant cartridge and mixed in a Hauschild SpeedMixer™ DAC 600 at 2350 rpm for 10 minutes.

For each example, multiple batches were prepared. The batches were then combined and molded in a press at 2500 psi and at 150° C. to make 150 mm×150 mm×2 mm thick sheets. The final formulation for the silicone elastomer polymer compositions are summarized in Table 1 below.

TABLE 1

| Material | Mass (g) | Percent |
|---|---|---|
| Silicone polymer (DMS-V33) | 25.68 | 27.65 |
| Alumina Filler | 65.0 | 70.00 |
| Crosslinker (HMS-151) | 2.1 | 2.24 |
| Inhibitor (SIT 7900) | 0.060 | 0.06 |
| Catalyst (SIP 6829) | 0.040 | 0.04 |

The specific amounts and types of alumina fillers used in each example are shown in Table 2 below.

TABLE 2

| Example # | “Coarse” alumina | Fumed Alumina | |
|---|---|---|---|
| 1 | 58.5 g | 6.5 | g |
| 2 | 52.0 g | 13.0 | g |
| Comp Ex 1 | 65.0 g | 0.0 | g |

The “coarse” alumina filler was AC34B6, available from Alcan, having an average particle size (d₅₀) of 6 μm. The fumed alumina was SpectrAl® 81, available from Cabot Corporation, having an average particle size of 0.15-0.3 μm.

The molded elastomer sheets were tested for tensile strength and elongation, as measures of the reinforcement effect of the fumed alumina in the composition. Testing was carried out on a Tech-Pro tensiTECH according to ASTM D-412. The results are summarized in Table 3 below.

TABLE 3

| Example # | Tensile Strength (MPa) | Elongation (%) |
|---|---|---|
| 1 | 1.93 | 99 |
| 2 | 2.26 | 113 |
| Comp Ex 1 | 0.79 | 25 |

As seen from Table 3, although the total percentage of alumina filler in the compositions was held constant in the Examples 1-2 and Comparative Example 1, the tensile strength of the thermal interface materials of the present invention (Examples 1-2) was more than doubled by replacing some of the “coarse” alumina with fumed alumina. At the same time, the elongation was increased by more than a factor of four. Therefore, the thermal interface materials of the present invention, comprising at least one filler having an average aggregate particle size of less than or equal to 1 micron, have improved mechanical properties.

### Examples 3-4

The following examples demonstrate an embodiment of the thermal interface material of the present invention, comprising a fumed alumina or a treated fumed alumina dispersed in a polymer.

For each example, compositions comprising a filler dispersed in PDMS were prepared. The PDMS was DMS-T41.2, a medium viscosity methyl terminated polydimethylsiloxane fluid available from Gelest, having a viscosity of 12,500 cSt. For Examples 3A-3D, the filler was a fumed alumina (SpectrAl® 81, available from Cabot Corporation, having an average aggregate particle size of 0.15-0.3 μm) while for Examples 4A-4D, the filler was a treated fumed alumina (SpectrAl® 81) modified with octyltriethoxysilane (OTES) (average aggregate particle size of less than 1 micron). A treated fumed alumina modified with octyltrimethoxysilane (OTMS) could also be used.

Samples were prepared from a masterbatch composition, which was used in order to achieve a good dispersion (Hegman grind approximately 5-6) of the fumed alumina in the PDMS fluid. The composition of the masterbatch is shown in Table 4 below. In all cases, the fumed alumina concentration in the masterbatch was 25% by weight.

TABLE 4

| Component | Mass (g) | Percent |
|---|---|---|
| DMS-T41.2 | 37.5 | 75 |
| Fumed Alumina | 12.5 | 25 |
| TOTAL | 50.0 | 100% |

The masterbatch composition was prepared by weighing the PDMS into a 100 Max cup. The fumed alumina was weighed separately and then wetted into the PDMS in three steps. In each step, the mixture was processed in a Hauschild Speedmixer™ DAC 150 at 1500 rpm for 1 minute. At the conclusion of each wet-in step, any material remaining on the sides of the cup was scraped into the bulk compound to ensure good incorporation. After the third addition, the mixture was ground for 5 minutes at 3500 rpm in the DAC 150.

A series of samples (A-C) with solids loading between 10 and 25 wt % were prepared from the masterbatch by diluting the concentrated compound with additional PDMS as needed. Thus, the appropriate amount of the masterbatch was added to a 20 Max cup followed by the requisite amount of PDMS. The mixture was processed on the DAC 150 at 1500 rpm for 1.5 min. All samples were cooled at ambient conditions prior to testing. The specific amounts used for each sample is shown in Table 5 below.

TABLE 5

| Sample | A | | B | | C | | D | |
|---|---|---|---|---|---|---|---|---|
| Amount of | 12.0 | g | 8.0 | g | 4.0 | g | 0.0 | g |
| DMS-T41.2 | | | | | | | | |
| Amount of | 8.0 | g | 12.0 | g | 16.0 | g | 20.0 | g |
| Masterbatch | | | | | | | | |
| TOTAL | 20.0 | g | 20.0 | g | 20.0 | g | 20.0 | g |
| Wt % fumed | 10 | wt % | 15 | wt % | 20 | wt % | 25 | wt % |
| alumina | | | | | | | | |

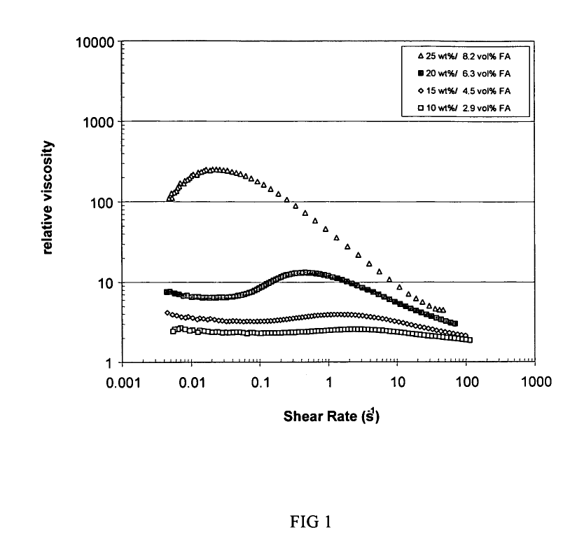

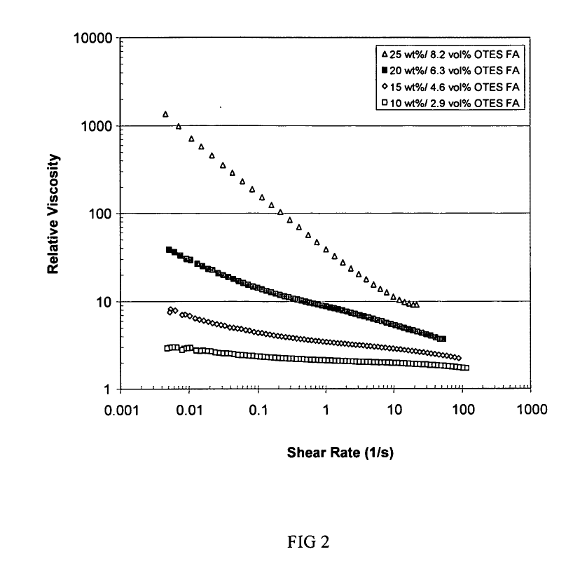

The samples were evaluated on a TA Instruments AR2000 rheometer using a 4 cm plate with a gap of 500 microns. The parallel and Peltier plates were affixed with a disk of 150-grit adhesive backed sandpaper to minimize wall slip. Each sample was presheared at 10 s⁻¹ for 2 minutes followed by a rest period of 10 minutes to remove handling history. All measurements were made at 25° C. The samples were equilibrated in the rheometer for 10 minutes prior to evaluation. Each of the samples were evaluated in stepped flow in controlled rate mode from 100 to 10⁻⁶ s⁻¹. The resulting flow profiles are shown in FIG. 1 (for Example 3) and FIG. 2 (for Example 4).

FIG. 1 and FIG. 2 illustrate how the use of a treated fumed alumina can reduce the viscosity and the presence of shear thickening in a model silicone system. In FIG. 1, shear thickening is observed in untreated fumed alumina at approximately 10% by weight, and this increases with increased loading. In contrast in FIG. 2, only shear thinning is observed over the equivalent loading range. Thus, the use of a treated fumed alumina in a PDMS composition, at least in part, has suppressed the onset of shear thickening. It would be expected that in compositions containing a blend of treatments, or a blend of treated and untreated fumed alumina, that shear thickening could also be suppressed.

Thus, while the polymer compositions of Example 3, comprising a fumed alumina, have desirable properties, those of Example 4, comprising a treated fumed alumina, show further improvements in rheological properties as well. It would be expected that the use of a treated fumed alumina in a polymer composition, such as that described in Examples 1-2, would also produce thermal interface materials having a desirable balance of rheological and physical properties.

The foregoing description of preferred embodiments of the present invention has been presented for the purposes of illustration and description. It is not intended to be exhaustive or to limit the invention to the precise form disclosed. Modifications and variations are possible in light of the above teachings, or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

What is claimed is:

1. A thermal interface material comprising a filler dispersed in a polymer, wherein the filler has an average aggregate particle size of less than or equal to 1 micron.

2. The thermal interface material of claim 1, wherein the filler is fumed alumina.

3. The thermal interface material of claim 2, wherein the fumed alumina has a surface area of greater than or equal to about 30 m²/g.

4. The thermal interface material of claim 2, wherein the fumed alumina has a surface area of greater than or equal to about 40 m²/g.

5. The thermal interface material of claim 2, wherein the fumed alumina has a surface area of greater than or equal to about 50 m²/g.

6. The thermal interface material of claim 3, wherein the fumed alumina has a surface area of less than or equal to about 100 m²/g.

7. The thermal interface material of claim 1, wherein the filler is a modified fumed alumina comprising a fumed alumina having attached at least one organic group.

8. The thermal interface material of claim 1, wherein the polymer is a polydimethylsiloxane resin, an epoxy resin, an acrylate resin, a organopolysiloxane resin, a polyimide resin, a fluorocarbon resin, a benzocyclobutene resin, a fluorinated polyallyl ether resin, a polyamide resin, a polyimidoamide resin, a cyanate ester resin, a phenol resol resin, an aromatic polyester resin, a polyphenylene ether resin, a bismaleimide triazine resin, a fluororesin, or combinations thereof.

9. The thermal interface material of claim 1, wherein the polymer is a polysiloxane resin.

10. The thermal interface material of claim 1, wherein the filler is dispersed in the polymer in an amount of between about 5% and about 80% by weight based on the total weight of the material.

11. The thermal interface material of claim 1, wherein the filler is dispersed in the polymer in an amount of between about 10% and about 70% by weight based on the total weight of the material.

12. The thermal interface material of claim 1, wherein the filler is dispersed in the polymer in an amount of between about 30% and about 60% by weight based on the total weight of the material.

13. The thermal interface material of claim 1 further comprising at least one second filler having an average aggregate particle size of greater than 1 micron.

14. The thermal interface material of claim 13, wherein the second filler is fused silica, finely divided quartz powder, amorphous silica, graphite, diamond, silicon carbide, aluminum hydrates, aluminum oxides, zinc oxides, aluminum nitrides, boron nitrides, coarse alumina, or combinations thereof.

15. The thermal interface material of claim 13, wherein the second filler and the fumed alumina are present in a ratio of from about 2/1 to about 5/1.

16. The thermal interface material of claim 13, wherein the second filler and the fumed alumina are present in a ratio of from about 3/1 to about 4/1.

17. The thermal interface material of claim 13, wherein the second filler and the fumed alumina are dispersed in the polymer in a total amount of between about 25% and about 90% by weight based on the total weight of the material.

18. The thermal interface material of claim 13, wherein the second filler and the fumed alumina are dispersed in the polymer in a total amount of between about 30% and about 85% by weight based on the total weight of the material.

19. The thermal interface material of claim 13, wherein the second filler and the fumed alumina are dispersed in the polymer in a total amount of between about 40% and about 90% by weight based on the total weight of the material.

20. The thermal interface material of claim 13, wherein the second filler is a modified alumina comprising an alumina having attached at least one organic group.

21. The thermal interface material of claim 1 further comprising at least one reinforcing filler.

22. The thermal interface material of claim 21, wherein the reinforcing filler is a fumed silica or a precipitated silica and the polymer is a polysiloxane resin.

23. The thermal interface material of claim 21, wherein the reinforcing filler is present in an amount of between about 0% to about 30% by weight based on the total weight of the material.

24. The thermal interface material of claim 21, wherein the reinforcing filler is present in an amount of between about 0% and about 10% by weight based on the total weight of the material.

25. An electronic component comprising: a) a heat generating component, b) a heat dissipating component, and c) a thermal interface material interposed between the heat generating component and the heat dissipating component, wherein the thermal interface material comprises a filler dispersed in a polymer, and wherein the filler has an average aggregate particle size of less than or equal to 1 micron.
